(19) United States
(12) Patent Application Publication
(10) Pub. No.: US 2023/0377181 A1
(43) Pub. Date: Nov. 23, 2023

(54) SENSING DEVICE FOR PROVIDING THREE DIMENSIONAL INFORMATION

(71) Applicant: eYs3D Microelectronics, Co., Taipei City (TW)

(72) Inventor: Chi-Feng LEE, Taipei City (TW)

(21) Appl. No.: 17/965,912

(22) Filed: Oct. 14, 2022

Related U.S. Application Data
(60) Provisional application No. 63/343,547, filed on May 19, 2022.

(30) Foreign Application Priority Data
Sep. 7, 2022 (TW) 111133877

(51) Int. Cl. G06T 7/55; H04N 5/225; G06T 7/70

(52) U.S. Cl. CPC G06T 7/55; H04N 5/2258; G06T 7/70; G06T 2207/20221; G06T 2207/10028

(57) ABSTRACT

A sensing device comprises a first sensor, a second sensor and a computing unit. The first sensor generates a plurality of first depth information with a first sampling rate and a first precision. The second sensor generates a plurality of second depth information with a second sampling rate and a second precision. The second sampling rate is greater than the first sampling rate, and the second precision is less than the first precision. The computing unit performs a fusion operation according to the first depth information and the second depth information to obtain a fused depth information. The fused depth information has the first precision and the second sampling rate.

This application claims the benefit of U.S. provisional application Ser. No. 63/343,547, filed May 19, 2022 and Taiwan application Serial No. 111133877, filed Sep. 7, 2022, the subject matters of which are incorporated herein by references.

### TECHNICAL FIELD

The present disclosure relates to a sensing device, and more particularly, to a sensing device for generating three-dimensional information and fusing three-dimensional information.

### BACKGROUND

Virtual reality (VR) technology and augmented reality (AR) technology have been greatly developed and widely used in daily life. The three-dimensional (3D) sensing technology of target objects is an indispensable core technology of VR and AR technologies. In order to establish a more accurate 3D image and 3D model of the target object, so that the target object may be realistically presented and achieve better visual effects in VR and AR, it is necessary to obtain 3D information with high resolution (corresponding to high sampling rate) and high depth precision. That is, the 3D information of the target object must have both high resolution in image on the projection plane and high precision in depth.

Various existing 3D sensing technologies have their own advantages. Some sensing technologies have high resolution in images on projection plane, while other sensing technologies have high precision in depth. To achieve both high resolution and high depth precision, two or more 3D sensing technologies must be fused. However, the existing fusion technology can only generate fused information in a unit of an “object” (i.e., a target object), and the fineness of the fused results needs to be improved.

In view of the above-mentioned technical problems of the prior art, those skilled in the art are devoted to improve the 3D sensing fusion technology, expecting the fused information may have both high resolution and high depth precision, so as to achieve fineness with a unit of a “pixel” or a “point”.

### SUMMARY

According to an aspect of the present disclosure, a sensing device is provided. The sensing device includes a first sensor, a second sensor and a computing unit. The first sensor is for generating a plurality of first depth information, wherein the first depth information has a first sampling rate and a first precision. The second sensor is for generating a plurality of second depth information, wherein the second depth information has a second sampling rate and a second precision, the second sampling rate is greater than the first sampling rate, and the second precision is less than the first precision. The computing unit is configured to perform a fusion operation according to the first depth information and the second depth information to obtain a fused depth information, the fused depth information has the first precision and the second sampling rate.

In an example of the present disclosure, the first depth information corresponds to a plurality of first coordinate positions of a projection plane, and the second depth information corresponds to a plurality of second coordinate positions of the projection plane, the fusion operation performed by the computing unit comprises mapping an original coordinate position of the second coordinate positions to a mapped coordinate position, and the mapped coordinate position is located among the first coordinate positions, selecting a plurality of engaging coordinate positions from the first coordinate positions according to the mapped coordinate position, and performing a weighting operation according to the first depth information corresponding to each of the engaging coordinate positions and the second depth information corresponding to the original coordinate position to obtain the fused depth information, and the fused depth information corresponds to the mapped coordinate position.

In an example of the present disclosure, the engaging coordinate positions are adjacent to the mapped coordinate position, the first depth information corresponding to each of the engaging coordinate positions has a weight value, and the computing unit performs the weighting operation at least according to the first depth information corresponding to each of the engaging coordinate positions and the weight value.

In an example of the present disclosure, the weight value is an error weight, and the error weight is related to an absolute error value between the first depth information corresponding to each of the engaging coordinate positions and the second depth information corresponding to the original coordinate position.

In an example of the present disclosure, the weight value is a distance weight, and the distance weight is related to a length of a relative distance between each of the engaging coordinate positions and the mapped coordinate position.

In an example of the present disclosure, the weight value is an area weight, and the area weight is related to a size of a relative area between each of the engaging coordinate positions and the mapped coordinate position.

In an example of the present disclosure, the first depth information corresponding to the engaging coordinate positions has a first confidence weight, and the second depth information corresponding to the original coordinate position has a second confidence weight, the computing unit performs the weighting operation according to the first depth information corresponding to the engaging coordinate positions, the first confidence weight, the second depth information corresponding to the original coordinate position and the second confidence weight.

In an example of the present disclosure, the computing unit is further configured to calculate a basis value of the second depth information, calculate an offset value of each of the second depth information with respect to the basis value, and correct the fused depth information according to the offset values of the second depth information.

In an example of the present disclosure, the first sensor and the second sensor have a plurality of intrinsic parameters and a plurality of extrinsic parameters, and the computing unit maps the original coordinate position to the mapped coordinate position according to the intrinsic parameters and/or the extrinsic parameters.

In an example of the present disclosure, the first sensor is a radar sensor or a depth sensor using time-of-flight (ToF), and the second sensor is a color sensor, a Lidar sensor or a stereoscopic sensor.

According to another aspect of the present disclosure, a sensing device is provided. The sensing device includes a first sensor, a second sensor and a computing unit. The first sensor is for generating a plurality of first depth information, wherein the first depth information has a first sampling rate and a first precision. The second sensor is for generating a plurality of pixels and a plurality of image values, the image values respectively correspond to the pixels, wherein the pixels have a resolution, and a sampling rate corresponding to the resolution is greater than the first sampling rate. The computing unit is configured to perform a fusion operation according to the first depth information and the image values to obtain a fused depth information, the fused depth information has the first precision, and sampling rate of the fused depth information is substantially equal to the sampling rate corresponding to the resolution of the pixels.

In an example of the present disclosure, the pixels generated by the second sensor form an image, and the fusion operation performed by the computing unit comprises establishing a sampling coordinate position among the first coordinate positions, mapping the first coordinate positions to a plurality of main mapped coordinate positions, the main mapped coordinate positions are located in the image, mapping the sampling coordinate position to a sampling mapped coordinate position, the sampling mapped coordinate position is located in the image, and performing a weighting operation according to the first depth information corresponding to each of the first coordinate positions, the image value corresponding to each of the main mapped coordinate positions and the image value corresponding to the sampling mapped coordinate position to obtain the fused depth information, the fused depth information corresponds to the sampling coordinate position.

In an example of the present disclosure, the computing unit selects a plurality of adjacent pixels from the pixels, the adjacent pixels are adjacent to the sampling mapped coordinate position and the main mapped coordinate positions, and the computing unit performs an interpolation operation according to the image values corresponding to the adjacent pixels to obtain the image values corresponding to the sampling mapped coordinate positions and the main mapped coordinate positions.

In an example of the present disclosure, each of the first depth information has a weight value, and the computing unit performs the weighting operation at least according to each of the first depth information and the corresponding weight value.

In an example of the present disclosure, the weight value of each of the first depth information is an error weight, and the error weight is related to an image-value-error between the image value corresponding to each of the main mapped coordinate positions and the image value corresponding to the sampling mapped coordinate positions.

According to still another aspect of the present disclosure, a sensing device is provided. The sensing device includes a first sensor and a computing unit. The first sensor is for generating a plurality of first depth information, the first depth information is related to at least one first space, the at least one first space has a plurality of first coordinate positions, the first depth information respectively corresponds to the first coordinate positions. The computing unit is configured to convert the first depth information into a plurality of second depth information, the second depth information is related to a standard space, and the standard space has at least one second coordinate position. When the second depth information points to the same one of the second coordinate position, the computing unit performs a fusion operation according to the second depth information to obtain a fused depth information of the second coordinate position.

In an example of the present disclosure, the first sensor generates the first depth information at different time points, and the standard space corresponds to a real-world coordinate system.

In an example of the present disclosure, the computing unit converts the first depth information into the second depth information according to a space conversion between the at least one first space and the standard space.

In an example of the present disclosure, each of the second depth information has a weight value, and the computing unit performs the fusion operation at least according to each of the second depth information and the corresponding weight value.

In an example of the present disclosure, the weight value of each of the second depth information is a confidence weight, and the confidence weight is related to a confidence level of each of the second depth information.

### BRIEF DESCRIPTION OF THE DRAWINGS

FIG. 1A is a schematic diagram of a sensing device according to an embodiment of the present disclosure.

FIG. 1B is a schematic diagram showing the first depth information and the first coordinate positions generated by the first sensor and the second depth information and the second coordinate positions generated by the second sensor of FIG. 1A.

FIG. 2 is a schematic diagram of a sensing device according to another embodiment of the present disclosure.

FIGS. 3 and 4 illustrate a fusion operation performed on the second depth information to obtain a fused depth information according to one original coordinate position of the second coordinate positions.

FIGS. 5A-5D illustrate different examples of the relation of the input value and output value of the error weight function.

FIGS. 6A-6D are schematic diagrams showing a weighting operation performed according to the first depth information and the error weight of the engaging coordinate positions to obtain the fused depth information of the mapped coordinate position.

FIGS. 7A-7D illustrate different examples of the relation of the input value and output value of the confidence weight function.

FIG. 8 shows an example of performing the fusion operation on the original coordinate position and the corresponding mapped coordinate position pm to obtain the corresponding fused depth information.

FIG. 9 illustrates another example of performing the fusion operation on the original coordinate position and the corresponding mapped coordinate position pm to obtain the corresponding fused depth information.

FIGS. 10A-10D are schematic diagrams showing the fused depth information is corrected.

FIG. 11 is a schematic diagram of a sensing device according to another embodiment of the present disclosure.

FIGS. 12A and 12B are schematic diagrams showing the fusion operation performed by the sensing device of FIG. 11.

FIG. 13 is a schematic diagram of a sensing device according to yet another embodiment of the present disclosure.

FIG. 14 is a schematic diagram showing the fusion operation performed by the sensing device of FIG. 13.

FIG. 15 is a schematic diagram of a sensing device according to still another embodiment of the present disclosure.

FIG. 16 is a schematic diagram showing the fusion operation performed by the sensing device of FIG. 15.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

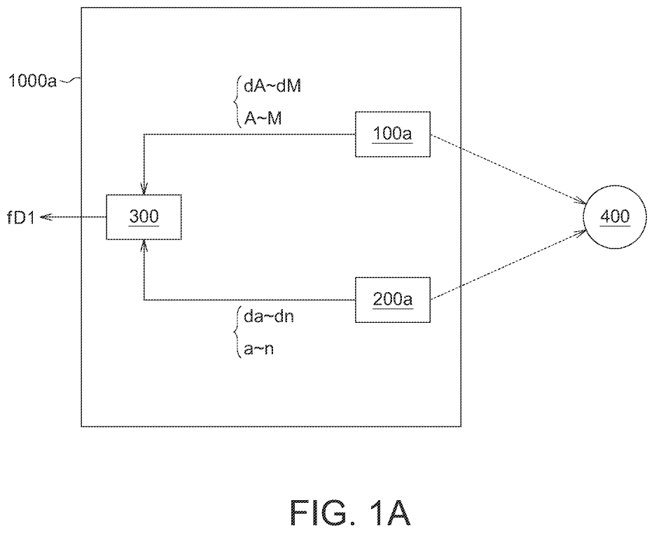

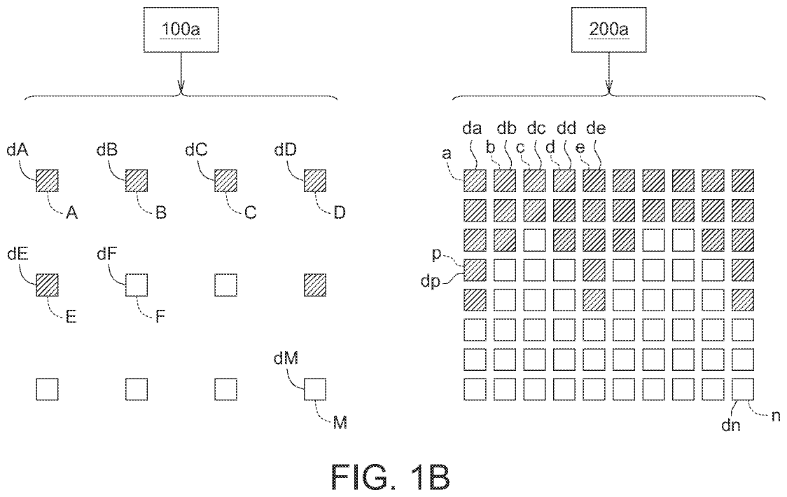

FIG. 1A is a schematic diagram of a sensing device 1000a according to an embodiment of the present disclosure. As shown in FIG. 1A, the sensing device 1000a includes a first sensor 100a, a second sensor 200a and a computing unit 300. The sensing device 1000a may perform three-dimensional (3D) sensing on the target 400 to establish 3D information related to the target 400. The first sensor 100a and the second sensor 200a respectively obtain different depth information related to the target 400, and the computing unit 300 performs a fusion operation based on the different depth information to obtain a plurality of fused depth information fD1, so as to establish more accurate 3D information.

The first sensor 100a generates a plurality of first depth information dA-dM related to the target 400. The first sensor 100a is, for example, a radar sensor (i.e., the corresponding second sensor 200a is a Lidar sensor), a depth sensor using time of flight (ToF) (i.e., the corresponding second sensor 200a is a color sensor or stereoscopic sensor, etc.), and so on. The depth sensor with ToF may utilize direct-ToF (dToF) or indirect-ToF (iToF). The first depth information dA-dM are, for example, absolute or relative depth information corresponding to a normal direction of a projection plane, such as depth map, disparity information, distance information, point cloud information, mesh information, etc. The first sensor 100a of this embodiment generates first depth information dA-dM in the normal direction. The first depth information dA-dM are projected on the first coordinate positions A-M of the projection plane, and the first depth information dA-dM respectively correspond to the first coordinate positions A-M.

The second sensor 200a generates a plurality of second depth information da-dn related to the target 400. The second sensor 200a is, for example, a Lidar sensor (i.e., the corresponding first sensor 100a is a radar sensor), a color sensor, a sensor using monocular-vision or stereoscopic, and so on. The second sensor 200a of this embodiment generates the second depth information da-dn. The second depth information da-dn are projected on the second coordinate positions a-n of the projection plane, and the second depth information da-dn respectively correspond to the second coordinate positions a-n. Regarding the depth precision and sampling rate, the second depth information da-dn generated by the second sensor 200a are different from the first depth information dA-dM generated by the first sensor 100a.

FIG. 1B is a schematic diagram showing the first depth information dA-dM and the first coordinate positions A-M generated by the first sensor 100a and the second depth information da-dn and the second coordinate positions a-n generated by the second sensor 200a of FIG. 1A. As shown in FIG. 1B, the first depth information dA-dM are projected on the first coordinate positions A-M of the projection plane, and the first depth information dA-dM corresponds to the normal direction of the projection plane. According to the first depth information dA-dM and the first coordinate positions A-M, the (x, y, z) 3D coordinates (not shown in FIG. 1B) may be calculated. The (x, y, z) 3D coordinates cover the projection plane and normal direction. In an example, when the first sensor 100a generates points cloud, the depths of the points in the point cloud may be represented as first depth information dA-dM, and each point may directly correspond to the (x, y, z) 3D coordinate.

Each of the first depth information dA-dM has a first precision and a first sampling rate. The first precision is defined as: the precision of the depth sensing for the first sensor 100a on the target 400, that is, the precision of the first depth information dA-dM in the normal direction. The first sampling rate is defined as: the sampling rate of the first sensor 100a on the projection plane when sensing the target 400. Which is, when the first depth information dA-dM are projected on the projection plane, the equivalent sampling rate on the projected plane for the first depth information dA-dM. The first sensor 100a has higher precision in depth sensing, but the sampling rate of the first sensor 100a on the projection plane is lower, therefore, the first precision of the first depth information dA-dM is higher, but the first sampling rate is lower.

On the other hand, the second depth information da-dn generated by the second sensor 200a are related to the normal direction of the projection plane, and the second depth information da-dn are projected on the second coordinate positions a-n of the projection plane. The (x, y, z) 3D coordinates may be calculated according to the second depth information da-dn and the second coordinate positions a-n. Each of the second depth information da-dn has a second precision and a second sampling rate. The second precision is defined as: the precision of the second depth information da-dn in the normal direction. The second sampling rate is defined as: “the equivalent sampling rate” of the second depth information da-dn on the projection plane when the second depth information da-dn are projected on the projection plane. The sampling rate of the second sensor 200a on the projection plane is higher, but the precision of the depth sensing of the second sensor 200a is lower. Therefore, the second sampling rate of the second depth information da-dn is higher but the second precision is lower. The second sampling rate of the second depth information da-dn is greater (or higher) than the first sampling rate of the first depth information dA-dM, but the second precision of the second depth information da-dn is smaller (or lower) than the first precision of the first depth information dA-dM.

The computing unit 300 performs a fusion operation according to the first depth information dA-dM and the second depth information da-dn of different precisions and sampling rates to obtain the fused depth information fD1. The fused depth information fD1 may have both a higher first precision and a higher second sampling rate. Compared with other fusion techniques which performs the fusion operation in a unit of an object (e.g., the target 400), the computing unit 300 of the sensing device 1000a of the present disclosure performs fusion operation in a unit of depth information, for example, one second depth information dp of the second depth information da-dn is used as a unit to perform fusion operation. The fused depth information obtained by operating each of the depth information may be integrated into an overall fused depth information fD1.

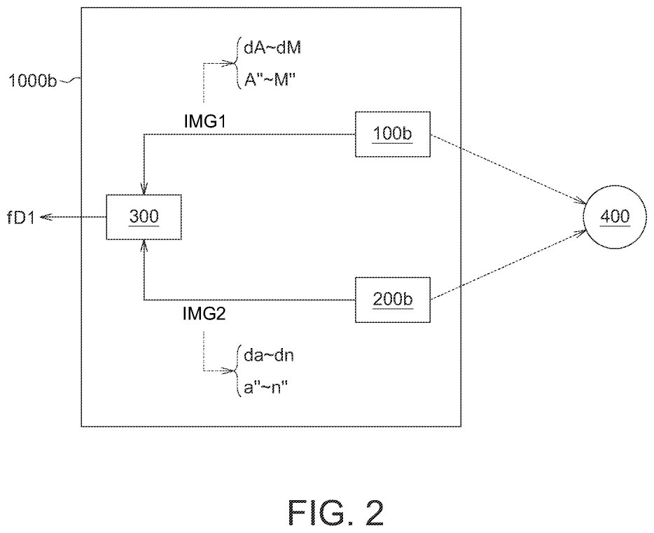

FIG. 2 is a schematic diagram of a sensing device 1000b according to another embodiment of the present disclosure. The sensing device 1000b of FIG. 2 is similar to the sensing device 1000a of FIG. 1A, except that, one or both of the first sensor 100b and the second sensor 200b of the sensing device 1000b may generate specific 2D images. For example, in addition to generating the first depth information dA-dM in the normal direction, the first sensor 100b may further generate a first image IMG1 corresponding to the projection plane of the first depth information dA-dM. That is, the basis plane of the first image IMG1 is substantially the projection plane of the first depth information dA-dM. The first image IMG1 includes a plurality of first pixels A″-M″, and the coordinate positions of the first depth information dA-dM projected on the projection plane are the positions of the first pixels A″-M″. That is, the positions of the first pixels A″-M″ in this embodiment substantially correspond to the first coordinate positions A-M of the embodiment of FIG. 1A. The first sampling rate of the first depth information dA-dM is substantially equal to the sampling rate corresponding to the resolution of the first pixels A″-M″ in the first image IMG1.

On the other hand, in addition to generating the second depth information da-dn in the normal direction, the second sensor 200b may also generate the second image IMG2 of the projection plane. The basis plane of the second image IMG2 is substantially the projection plane of the second depth information da-dn. The second image IMG2 includes a plurality of second pixels a″-n″. The positions of the second pixels a″-n″ on the projection plane substantially correspond to the second coordinate positions a-n of the embodiment in FIG. 1A. The sampling rate corresponding to the resolution of the second pixels a″-n″ in the second image IMG2 is substantially equal to the second sampling rate of the second depth information da-dn.

The operation of the sensing device 1000b of this embodiment is similar to the sensing device 1000a of FIG. 1A, wherein the computing unit 300 performs fusion operation to obtain a plurality of fused depth information fD1 based on the first depth information dA-dM generated by the first sensor 100b and the second depth information da-dn generated by the device 200b. When the fusion operation of the sensing device 1000a of FIG. 1A uses the first coordinate positions A-M and the second coordinate positions a-n of FIG. 1B, it is similar to the fusion operation of the sensing device 1000b of FIG. 2 that, using the positions of the first pixels A″-M″ and the positions of the second pixels a″-n″.

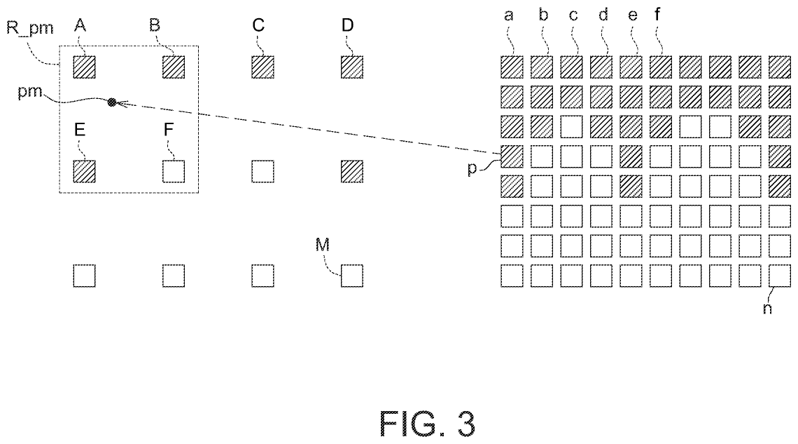

In the following, the sensing device 1000a of FIGS. 1A and 1B is taken as an example to illustrate the fusion operation of FIGS. 3-9. That is, the fusion operation of FIGS. 3-9 is performed based on the first depth information dA-dM and the first coordinate positions A-M generated by the first sensor 100a and the second depth information da-dn and the second coordinate positions a-n generated by the second sensor 200a of FIGS. 1A and 1B.

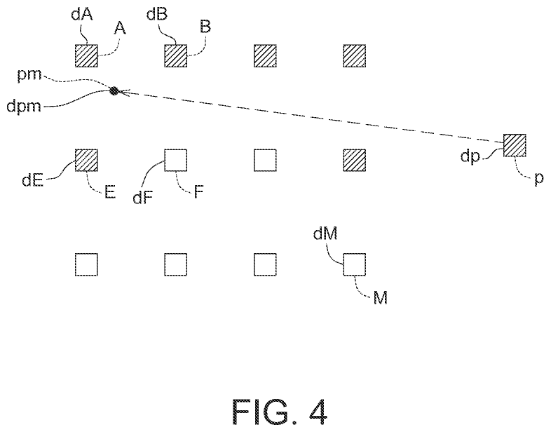

FIGS. 3 and 4 illustrate that, a fusion operation is performed on the second depth information dp to obtain a fused depth information dpm according to one original coordinate position p of the second coordinate positions a-n. In order to make the overall fused depth information fD1 have both the second sampling rate of the second depth information da-dn and the first precision of the first depth information dA-dM, the second depth information da-dn are mapped to the first depth information dA-dM to perform fusion operation. As shown in FIG. 3, a second coordinate position p (also referred to as “original coordinate position p”) is selected from the second coordinate positions a-n corresponding to the second depth information da-dn, and the original coordinate position p is mapped between the first coordinate positions A-M corresponding to the first depth information dA-dM, and becomes the mapped coordinate position pm. In one example, the mapping relationship between the original coordinate position p and the mapped coordinate position pm is calculated based on the intrinsic parameters of each of the first sensor 100 and the second sensor 200 and/or the extrinsic parameters between the first sensor 100 and the second sensor 200. The original coordinate position p is mapped to the mapped coordinate position pm according to the above-mentioned intrinsic parameters and/or extrinsic parameters. For example, when the optical center of the first sensor 100 is different from that of the second sensor 200, the correlation between the first sensor 100 and the second sensor 200 may be obtained through calibration, and then obtaining the extrinsic parameters between the first sensor 100 and the second sensor 200. Also, the respective intrinsic parameters of the first sensor 100 and the second sensor 200 may be obtained through calibration or other algorithms.

Then, the computing unit 300 selects a plurality of “engaging coordinate positions” from the first coordinate positions A-M according to the mapped coordinate position pm, and these engaging coordinate positions are adjacent to the mapped coordinate position pm. In one example, the coordinate value of the mapped coordinate position pm may be unconditionally rounded-off to obtain the first coordinate position A, that is, the first coordinate position A has the shortest distance from the mapped coordinate position pm. Then, selecting the first coordinate position E below the first coordinate position A, selecting the first coordinate position B to the right of the first coordinate position A, and selecting the first coordinate position F to the right and below the first coordinate position A. The selected first coordinate positions A, B, E and F are used as engaging coordinate positions.

In another example, an engaging area R_pm may be defined according to the mapped coordinate position pm, and the first coordinate positions located in the engaging area R_pm are selected as the engaging coordinate positions. For example, with the mapped coordinate position pm as the center, a circular area with a specific radius is defined as the engaging area R_pm. Alternatively, taking the mapped coordinate position pm as the geometric center, a rectangular area with specific length and width is defined as the engaging area R_pm.

Next, referring to FIG. 4, a fusion operation is performed according to the first depth information dA, dB, dE and dF corresponding to the engaging coordinate positions A, B, E and F and the second depth information dp of the original coordinate position p, to obtain the fused depth information dpm for mapped coordinate position pm. The first depth information dA, dB, dE and dF each has a weight value, and a weighting operation may be performed according to the above-mentioned weight values to achieve the fusion operation. In one example, the weight values of the first depth information dA, dB, dE and dF are error weights weA, weB, weE and weF. Taking the error weight weA as an example, it is calculated as equation (1):

weA=we(diffA)=we(|dA−dp|) (1)

In equation (1), the absolute error value diffA is defined as: the absolute value of the difference between the first depth information dA corresponding to the first coordinate position A and the second depth information dp corresponding to the original coordinate position p. The absolute error value diffA is inputted to the error weight function we( ) and the error weight function we( ) correspondingly outputs error weight weA. The error weight function we( ) is, for example, a linear function conversion, a nonlinear function conversion, or a look-up-table conversion. When the inputted absolute error value diffA is small, the error weight function we( ) correspondingly outputs larger value of error weight weA.

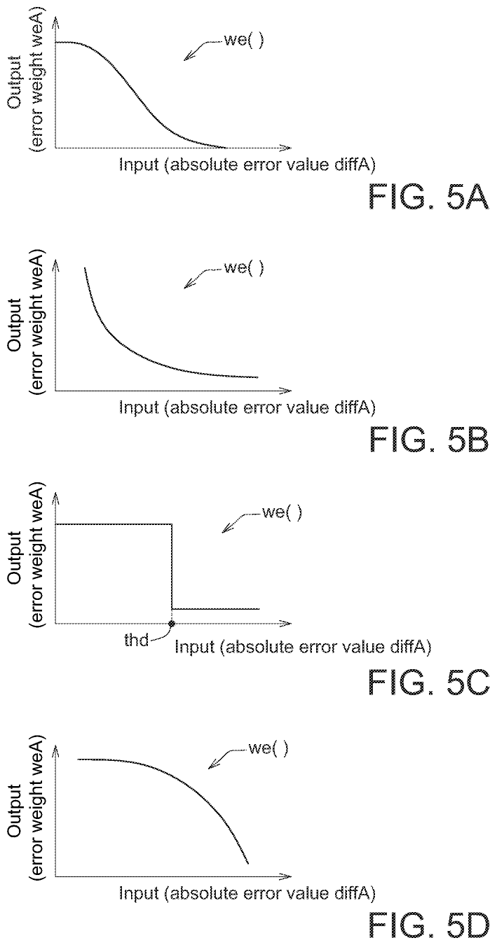

Please refer to FIGS. 5A-5D, which illustrate different examples of relation of the input value and output value of the error weight function we( ) In the example of FIG. 5A, the middle of the curve of the error weight function we( ) is substantially a linear region, when the inputted absolute error value diffA is larger the outputted error weight weA is smaller. In the example of FIG. 5B, the error weight function we( ) is a nonlinear function conversion, and the error weight function we( ) is related to a concave curve. In the example of FIG. 5D, the error weight function we( ) is related to a convex curve.

In the example of FIG. 5C, the curve of the error weighting function we( ) is a stepped line, and the descending edge of the step corresponds to the threshold thd. When the absolute error value diffA is less than the threshold value thd, the corresponding outputted error weight weA is “1”. When the absolute error value diffA is greater than the threshold value thd, the correspondingly outputted error weight weA is a value close to “0”.

Similarly, the error weights weB, weE and weF are calculated according to equations (2) to (4):

weB=we(diffB)=we(|dB−dp|) (2)

weE=we(diffE)=we(|dE−dp|) (3)

weF=we(diffF)=we(|dF−dp|) (4)

Then, a weighting operation is performed according to the first depth information dA, dB, dE and dF and the corresponding error weights weA, weB, weE and weF to obtain a weighting operation result dpm1. The weighting operation result dpm1 of the first depth information dA, dB, dE and dF is the fused depth information dpm of the mapped coordinate position pm, as shown in equation (5-1):

$$dpm = dpm 1 = \frac{{\sum }_{i = A , B , E , F} ( d i * w e i )}{{\sum }_{i = A , B , E , F} ( w e i )} = \frac{d A * w e A + d B * w e B + d E * w e E + d F * w e F}{w e A + w e B + w e E + w e F} \qquad ( 5 - 1 )$$

Similar to the fusion operation of the mapped coordinate position pm corresponding to the original coordinate position p, the same fusion operation may be performed for other coordinate positions among the second coordinate positions a-n. The fused depth information of the mapped coordinate positions (not shown in the FIG.) of each of the second coordinate positions a-n may be integrated into the overall fused depth information fD1.

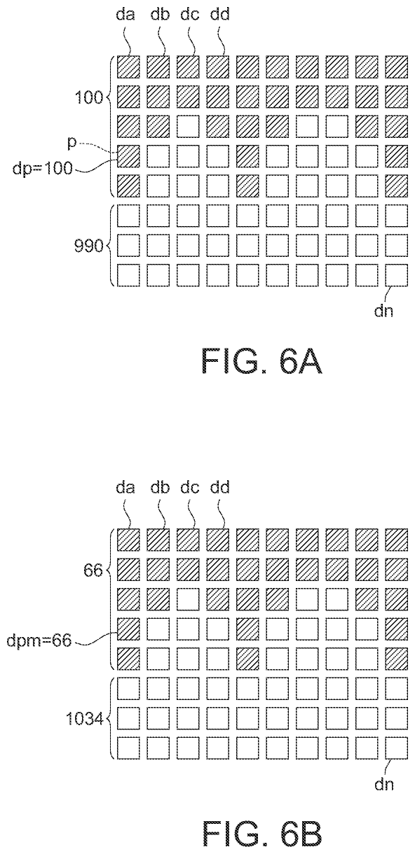

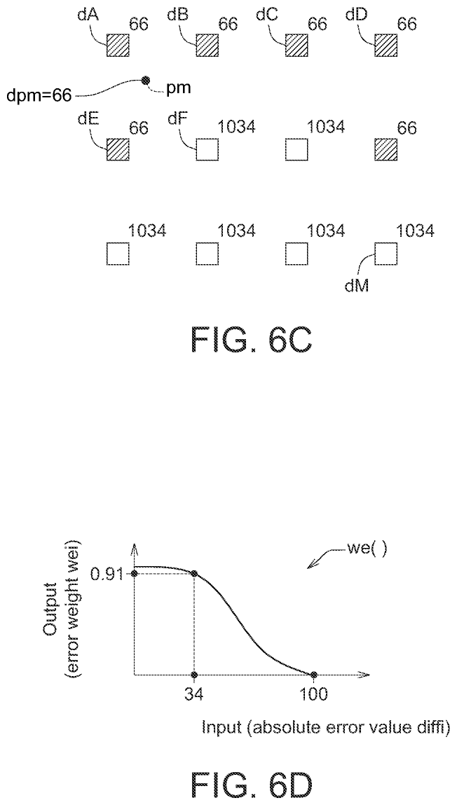

FIGS. 6A-6D are schematic diagrams showing a weighting operation is performed according to the first depth information and the error weight of the engaging coordinate positions A, B, E and F to obtain the fused depth information dpm of the mapped coordinate position pm. Referring to FIG. 6A, each of the second depth information da-dn (corresponding to the second coordinate positions a-n) generated by the second sensor 200a has, for example, a value of “100” or a value of “990”. In FIG. 6A, the second depth information corresponding to the second coordinate position of the dark block has a value of “100”, and the second depth information corresponding to the second coordinate position of the white screen bottom has a value of “990”. The second precision of the second depth information da-dn is relatively low (i.e., the value “100” or a value of “990” of the second depth information da-dn has an error), which needs to be corrected with the first depth information.

Next, referring to FIG. 6C, the first depth information dA-dM (corresponding to the first coordinate positions A-M) generated by the first sensor 100a has, for example, a value of “66” or “1034”. Wherein, the first depth information corresponding to the first coordinate position of the dark screen bottom has a value of “66”, and the first depth information corresponding to the first coordinate position of the white screen bottom has a value of “1034”. In addition, the original coordinate position p of FIG. 6A is mapped to the mapped coordinate position pm of FIG. 6C.

The engaging coordinate positions A, B, E and F adjacent to the mapped coordinate position pm correspond to the first depth information dA, dB, dE and dF. Wherein, the absolute error value diffA between the first depth information dA (with the value “66”) and the second depth information dp (with the value “100”) at the original coordinate position p is “34”. Please also refer to FIG. 6D, when the absolute error value diffi (i=A) is “34”, the corresponding error weight wei (i=A) is “0.91”, that is, the error weight weA of the first depth information dA is “0.91”. Similarly, each of the first depth information dB and dE has the value of “66” with the absolute error value diffi (i=B,E) of “34”, and the corresponding error weight wei (i=B,E) is “0.91”. On the other hand, the first depth information dF is a numerical value “1034”, and its absolute error value diffi (i=F) is “934” which exceeds the input upper limit value “100” shown in FIG. 6D. Therefore, the corresponding error weight wei (i=F) is “0”.

From the above, the error weights weA, weB, weE and weF of the first depth information dA, dB, dE and dF corresponding to the engaging coordinate positions A, B, E and F are “0.91”, “0.91”, “0.91” and “0”, therefore, the fused depth information dpm of the mapped coordinate position pm may be obtained through the weighting operation of equation (5-2):

$$dpm = \frac{{\sum }_{i = A , B , E , F} ( d i * w e i )}{{\sum }_{i = A , B , E , F} ( w e i )} = \frac{66 * 0.91 + 66 * 0.91 + 66 * 0.91 + 1034 * 0}{0.91 + 0.91 + 0.91 + 0} = 66 \qquad ( 5 - 2 )$$

According to the weighting operation of equation (5-2), the second depth information dp corresponding to the original coordinate position p (the value “100” in FIG. 6A) is corrected to the fused depth information dpm (the value “66”) in FIG. 6B. Similarly, the second depth information shown as the second coordinate position of the white screen bottom in FIG. 6A is corrected from the original value “990” to the value “1034” in FIG. 6B.

In another example, the weighting operation result dpm1 of the first depth information dA, dB, dE and dF in the engaging coordinate positions A, B, E and F may be further weighted with the second depth information dp of the original coordinate position p to obtain a weighting operation result. The weighting operation result dpm2 is obtained and is used as the final fused depth information dpm, as shown in equation (6):

$$dpm = dpm 2 = \frac{dpm 1 * wc 1 + dp * wc2}{w c 1 + w c 2} \qquad ( 6 )$$

In the weighting operation of equation (6), each of the first depth information dA, dB, dE and dF corresponding to the engaging coordinate positions A, B, E and F has a first confidence weight wc1, which is related to the confidence level CL1 (i.e., reliability level) of the first depth information dA, dB, dE and dF. In an example, the confidence level CL1 of the first depth information of the stereoscopic of the first sensor 100 may be calculated according to the cost value of the block matching related to the first sensor 100. The cost value related to the first sensor 100 is, for example, a minimum cost, a uniqueness, and etc. In another example, the confidence level CL1 of the first sensor 100 may be calculated according to a left right check or a noise level check. In yet another example, the first sensor 100 is a ToF sensor, and the confidence level CL1 of the ToF sensor may be calculated according to the reflected light intensity of the object (e.g., the object 400 in FIG. 1A). The reflected light intensity is proportional to the value of the confidence level CL1. Alternatively, if the first sensor 100 is an iToF sensor, the confidence level CL1 of the iToF sensor may be calculated according to the phase difference and amplitude (i.e., the phase difference corresponds to the distance, and the amplitude corresponds to the reflected light intensity) of the signals of different phases (i.e. quad signals). The first confidence weight wc1 of the first depth information dA, dB, dE and dF is calculated as equation (7-1):

wc1=wc(CL1) (7-1)

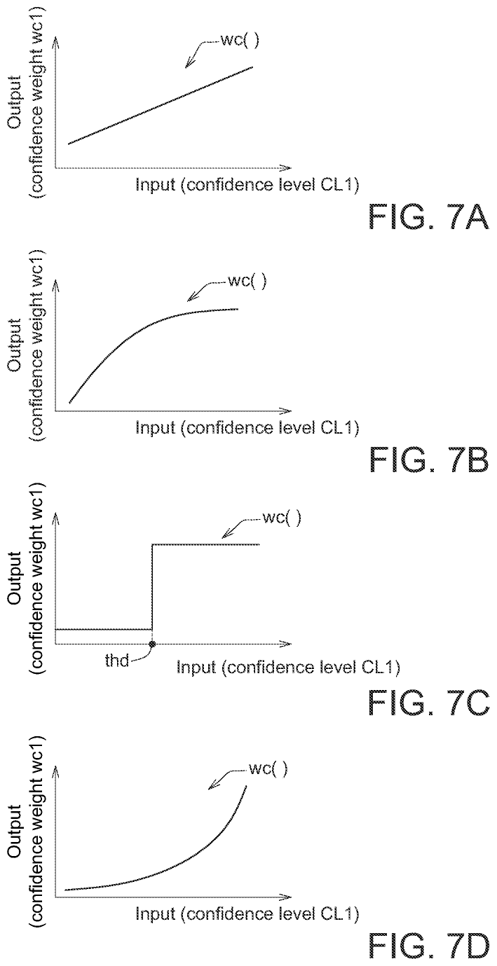

In equation (7-1), the confidence level CL1 is inputted to the confidence weight function wc( ) and the confidence weight function wc( ) outputs the first confidence weight wc1 correspondingly. See FIGS. 7A-7D, which illustrate different examples of relations of the input value and output value of the confidence weight function wc( ) The confidence weight function wc( ) is, for example, a linear function conversion, a nonlinear function conversion, or a look-up-table conversion. In the example in FIG. 7A, the confidence weight function wc( ) is a linear function conversion, and when the input confidence level CL1 is larger, the correspondingly outputted first confidence weight wc1 is larger. In the examples of FIGS. 7B and 7D, the confidence weight function wc( ) is a nonlinear function conversion, and the confidence weight function wc( ) is a convex curve and a concave curve. In the example of FIG. 7C, the confidence weight function wc( ) has a stepped line shape, and the rising edge of the step corresponds to the threshold value thc. When the inputted confidence level CL1 is smaller than the threshold value thc, the outputted first confidence weight wc1 is a value close to “0”. When the inputted confidence level CL1 is greater than the threshold value thc, the outputted first confidence weight wc1 is “1”.

Similarly, the second depth information dp corresponding to the original coordinate position p has a second confidence weight wc2, which is related to the confidence level CL2 of the second depth information dp, as shown in equation (7-2):

wc2=wc(CL2) (7-2)

From the above, according to the first depth information dA, dB, dE and dF of the engaging coordinate positions A, B, C and D, the first confidence weight wc1, the second depth information dp and the second confidence weight wc2 of the original coordinate position p, a weighting operation is performed to obtain a weighting operation result dpm2, and the weighting operation result dpm2 is used as the final fused depth information dpm.

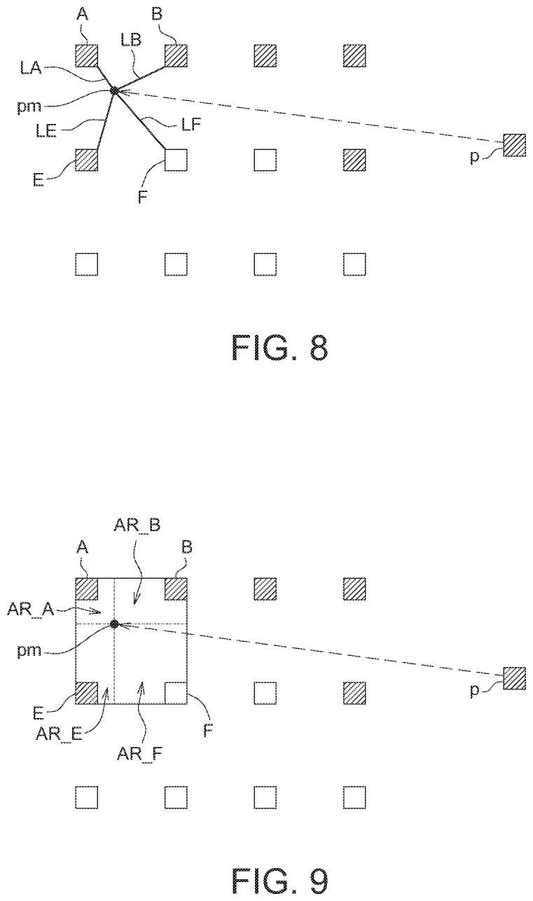

FIG. 8 shows an example of performing a fusion operation on the original coordinate position p and the corresponding mapped coordinate position pm to obtain the corresponding fused depth information dpm. In this example, the weight values of the first depth information dA, dB, dE and dF are calculated according to the relative distances between the engaging coordinate positions A, B, E and F and the mapped coordinate position pm. As shown in FIG. 8, there is a relative distance LA between the engaging coordinate position A and the mapped coordinate position pm, a relative distance LB between the engaging coordinate position B and the mapped coordinate position pm, and a relative distance LE between the engaging coordinate position E and the mapped coordinate position pm, and a relative distance LF between the engaging coordinate position F and the mapped coordinate position pm. According to the relative distances LA, LB, LE, LF and the distance weight function wd( ) the respective distance weights wdA, wdB, wdE and wdF of the first depth information dA, dB, dE and dF may be calculated by equation (8):

wdi=wd(Li)i=A,B,E,F (8)

In equation (8), the relative distance Li is the input value of the distance weight function wd( ) and the distance weight wdi is the output value of the distance weight function wd( ) The conversion relationship between the input value and the output value of the distance weight function wd( ) is similar to the error weight function we( ) in FIGS. 5-1 to 5-4. The distance weight function wd( ) is, for example, linear function conversion, nonlinear function conversion (including convex curve, concave curve, or stepped linear shape) or look-up-table conversion. When the relative distance Li inputted to the distance weight function wd( ) is larger, the outputted distance weight wdi is smaller. That is, the farther the engaging coordinate positions A, B, E, and F are located from the mapped coordinate position pm, the smaller the corresponding distance weights wdA, wdB, wdE and wdF.

Then, a weighting operation is performed according to the first depth information dA, dB, dE and dF, the corresponding distance weights wdA, wdB, wdE and wdF, and the error weights weA, weB, weE and weF to obtain a weighting operation result dpm3. The weighting operation result dpm3 is used as the fused depth information dpm, as shown in equation (9):

$$dpm = dpm 3 = \frac{{\sum }_{i = A , B , E , F} ( d i * wei * wdi )}{{\sum }_{i = A , B , E , F} ( wei * wdi )} = \frac{dA * weA * w d A + d B * w e B * w d B + d E * w e E * w d E + d F * w e F * wdF}{weA * w d A + w e B * w d B + w e E * w d E + w e F * wdF} \qquad ( 9 )$$

FIG. 9 illustrates another example of performing a fusion operation on the original coordinate position p and the corresponding mapped coordinate position pm to obtain the corresponding fused depth information dpm. In this example, the weight values of the first depth information dA, dB, dE and dF are calculated according to the “relative area” between the engaging coordinate positions A, B, E and F and the mapped coordinate position pm. More specifically, taking the mapped coordinate position pm as the center of the cross line, the area surrounded by engaging coordinate positions A, B, E and F is cut into four sub-regions according to the cross line, and the area of each sub-region is defined as “relative area” between the engaging coordinate position A, B, E and F and the mapped coordinate position pm. As shown in FIG. 9, there is a relative area AR_A between the engaging coordinate position A and the mapped coordinate position pm, a relative area AR_B between the engaging coordinate position B and the mapped coordinate position pm, and a relative area AR_E between the engaging coordinate position E and the mapped coordinate position pm, a relative area AR_F between the engaging coordinate position F and the mapped coordinate position pm. According to the relative areas AR_A, AR_B, AR_E and AR_F and the area weight function wa( ), the area weights waA, waB, waE and waF of the engaging coordinate positions A, B, E and F may be calculated as equation (10):

wai=wa(AR_i),i=A,B,E,F (10)

The conversion relationship of input value and output value of the area weight function wa( ) is similar to that of the distance weight function wd( ). When the engaging coordinate positions A, B, E and F are far away from the mapped coordinate position pm, the corresponding relative area AR_i is larger, and the area weight wai outputted by the area weight function wa( ) is smaller.

Then, a weighting operation is performed according to the first depth information dA, dB, dE and dF, the corresponding area weights waA, waB, waE and waF, and the error weights weA, weB, weE and weF to obtain a weighting operation result dpm4. The weighting operation result dpm4 is used as the fused depth information dpm, as shown in equation (11):

$$dpm = dpm 4 = \frac{{\sum }_{i = A , B , E , F} ( d i * wei * wai )}{{\sum }_{i = A , B , E , F} ( wei * wai )} = \frac{dA * weA * w a A + d B * w e B * w a B + d E * w e E * w a E + d F * w e F * waF}{weA * w a A + w e B * w a B + w e E * w a E + w e F * waF} \qquad ( 11 )$$

In another example, two or three of the aforementioned error weight function we( ) distance weight function wd( ) and area weight function wa( ) may also be integrated into a single function. For example, the error weight function we( ) and the distance weight function wd( ) are integrated into a hybrid weight function wm1( ). The absolute error value diffi and the relative distance Li (where i=A, B, E, F) are the input values of the hybrid weight function wm1( ), and the hybrid weight function wm1( ) correspondingly outputs hybrid weight wm1i, as shown in equation (12). When the absolute error value diffi is larger or the relative distance Li is larger, the outputted hybrid weight wm1i is smaller.

wm1i=wm1(Li,diffi)i=A,B,E,F (12)

Alternatively, the error weight function we( ) and the area weight function wa( ) are integrated into a hybrid weight function wm2( ). The absolute error value diffi and the relative area AR_i (where i=A, B, E, F) are the input values of the hybrid weight function wm2( ) and the hybrid weight function wm2( ) correspondingly output hybrid weight wm2i, as shown in equation (13):

wm2i=wm2(AR_i,diffi)i=A,B,E,F (13)

In another example, the weight selection function W(i1,i2, . . . , in) provides weight values wA, wB, wE and wF of the first depth information dA, dB, dE and dF. The weight selection function W(i1,i2, . . . , in) has multiple input values i1-in, and the input values i1-in are related rather than independent. The weight selection function W(i1,i2, . . . , in) may comprehensively judge according to the input values i1-in, and output the weight values wA, wB, wE and wF accordingly. For example, when the input values i1-in as a whole satisfy a specific condition, the outputted weight values wA, wB, wE and wF are “1”, “0”, “0” and “0”. In this case, only the weight value wA is “1”, hence only the first depth information dA is selected to calculate the fused depth information dpm. For another example, when the input values i1-in as a whole satisfy another specific condition, the outputted weight values wA, wB, wE and wF are “0”, “0”, “1” and “1”. In this case, the first depth information dE and the first depth information dF are selected to calculate the fused depth information dpm. From the above, in some examples, one or more of the first depth information dA, dB, dE and dF may be selected by the weight selection function W(i1,i2, . . . , in) to calculate the fused depth information dpm.

In the above, the fusion operations in FIGS. 3-9 may also be implemented by the sensing device 1000b in FIG. 2. When the sensing device 1000b of FIG. 2 performs the fusion operation of FIGS. 3-9, the first coordinate positions A-M and the second coordinate positions a-n are respectively replaced with the positions of the first pixels A″-M″ and the positions of the second pixel a″-n″, and substantially the same result of the fusion operation may be obtained.

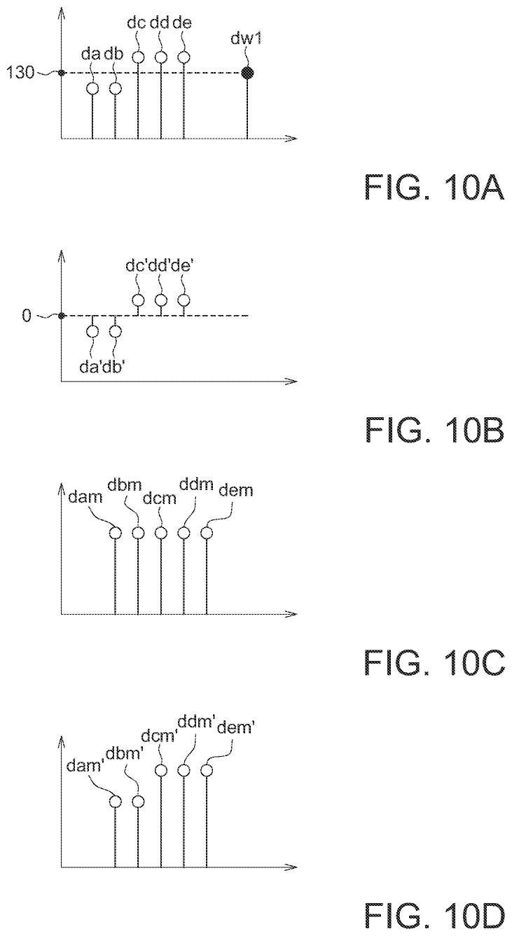

FIGS. 10A-10D are schematic diagrams showing the fused depth information is corrected. The second coordinate positions a-n of FIG. 1B may be divided into multiple blocks, for example, five of second coordinate positions a, b, c, d and e belong to the same block, and the corresponding second depth information da, db, dc, dd and de are performed weighting operation. Referring to FIG. 10A, a weighting operation is performed on the second depth information da, db, dc, dd and de to obtain a basis value dw1. For example, if the weighting operation is an average-value operation, the basis value dw1 is an average value of the second depth information da, db, dc, dd and de.

Next, referring to FIG. 10B, the basis value dw1 is respectively subtracted from the second depth information da, db, dc, dd and de to obtain the offset values da′, db′, dc′, dd′ and de′. For example, the values of the second depth information da, db, dc, dd and de are “100”, “100”, “150”, “150”, and “150” respectively, and the basis value dw1 for the average-value calculation is “130”, and the corresponding offset values da′, db′, dc′, dd′ and de′ are “−30”, “−30”, “20”, “20” and “20” respectively.

Next, referring to FIG. 100, a fusion operation is performed on the respective mapped coordinate positions of the second coordinate positions a, b, c, d and e, to obtain fused depth information dam, dbm, dcm, ddm and dem. Then, according to the offset values da′, db′, dc′, dd′ and de′ of FIG. 10B, the fused depth information dam, dbm, dcm, ddm and dem of FIG. 100 are corrected. For example, the fused depth information dam, dbm, dcm, ddm and dem are added by the offset values da′, db′, dc′, dd′ and de′ respectively, so as to obtain the corrected fused depth information dam′, dbm′, dcm′, ddm′ and dem′ of FIG. 10D.

There is an increasing trend in value between the corrected fused depth information dbm′ and the fused depth information dcm′, which may reflect the increasing trend in value between the original second depth information db and the second depth information dc in FIG. 10A.

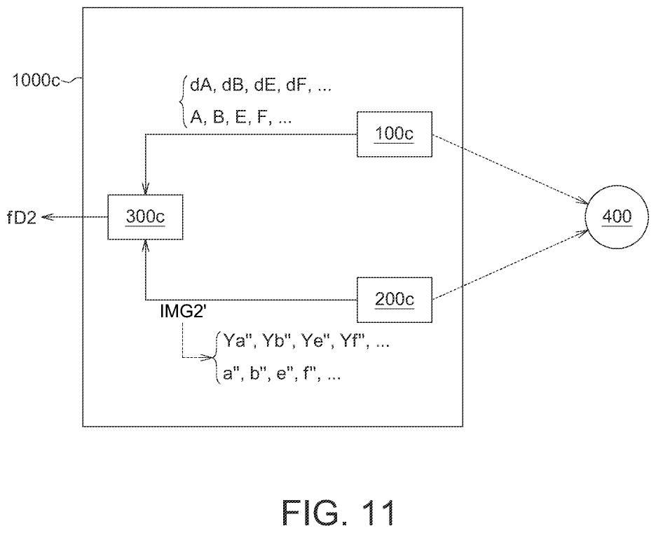

FIG. 11 is a schematic diagram of a sensing device 1000c according to another embodiment of the present disclosure. As shown in FIG. 11, the first sensor 100c of the sensing device 1000c is similar to the first sensor 100a of the embodiment shown in FIG. 1A, and the first sensor 100c of the present embodiment is used to generate a plurality of first depth information dA, dB, dE, dF, . . . etc. of target 400, which are projected to the first coordinate positions A, B, C, D, . . . etc. The first sensor 100c of this embodiment generates the first depth information dA, dB, dE and dF with a first precision and a first sampling rate.

On the other hand, the second sensor 200c of this embodiment is different from the second sensor 200a of FIG. 1A and the second sensor 200b of FIG. 2, where the second sensor 200c of this embodiment does not generate any depth information. The second sensor 200c of this embodiment is, for example, an image capturing device, which may generate an image IMG2′ related to the target 400. The image IMG2′ includes a plurality of pixels a″, b″, e″, f″, . . . etc. Furthermore, the pixels a″, b″, e″ and f″ have image values Ya″, Yb″, Ye″ and Yf″. Moreover, the image values Ya″, Yb″, Ye″ and Yf″ are, for example, color grayscale values or color index values. The image IMG2′ has a resolution, and the sampling rate corresponding to the resolution is greater than the first sampling rate of the first depth information dA, dB, dE and dF.

The computing unit 300c performs a fusion operation according to the first depth information dA, dB, dE and dF and the image values Ya, Yb, Ye and Yf, so as to obtain the fused depth information corresponding to each pixel. Each fused depth information may be integrated into the overall fused depth information fD2, and the fused depth information fD2 may have both the first precision of the first depth information dA, dB, dE and dF and the sampling rate corresponding to the resolution of the image IMG2′.

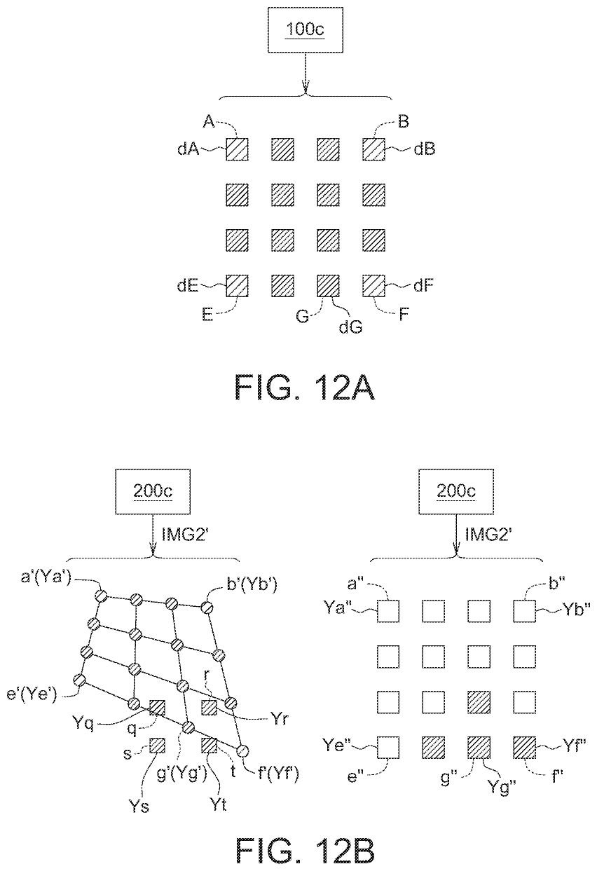

FIGS. 12A and 12B are schematic diagrams showing the fusion operation performed by the sensing device 1000c of FIG. 11. Referring to FIG. 12A, the first sampling rate of the first depth information dA-dF generated by the first sensor 100c on the projection plane is lower than the sampling rate corresponding to the resolution of the image IMG2′ generated by the second sensor 200c. In order to make the fused depth information fD2 reach the sampling rate corresponding to the resolution of the image IMG2′, the computing unit 300c samples more coordinate positions among the first coordinate positions A, B, E and F. For example, the sampling rate corresponding to the resolution of the image IMG2′ is three times the first sampling rate of the first depth information dA-dF, and the computing unit 300c creates twelve new sampling coordinate positions among the four original first coordinate positions A, B, E and F, including the sampling coordinate position G. The newly added sampling coordinate position G is located among the original first coordinate positions A, B, E and F.

Please refer to FIG. 12B, according to the intrinsic parameters and/or extrinsic parameters of the first sensor 100c and the second sensor 200c, the computing unit 300c may map the first coordinate positions A, B, E and F to the main mapped coordinate positions a′, b′, e and f′ in the image IMG2′. Then, the sampling coordinate position G is mapped to the sampling mapped coordinate position g′ in the image IMG2′. In one example, the computing unit 300c may apply the proportional relationship between the sampling coordinate position G and the relative positions of the first coordinate positions A to F to the image IMG2′, and then calculate the sampling mapped coordinated position g′ based on the main mapped coordinate positions a′, b′, e′ and f′. In another example, the sampling map coordinate position g′ may be calculated based on homography.

Since the main mapped coordinate positions a′, b′, e′ and f′ and the sampling mapped coordinate position g′ do not necessarily overlap with the original pixels a″, b″, e″, f″ and g″ of the image IMG2′″, so the image values Ya″, Yb″, Ye″, Yf″ and Yg″ corresponding to the original pixels a″, b″, e″, f″ and g″ may not be directly used. Interpolation must be performed to obtain the image values corresponding to the main mapped coordinate positions a′, b′, e′ and f′ and the sampling mapped coordinate position g′. For example, select a plurality of adjacent pixels q, s, r and t from the original pixels of the image IMG2′, these adjacent pixels q, s, r and t are adjacent to the sampling mapped coordinate position g′. Then, the interpolation operation is performed according to the image values Yq, Ys, Yr and Yt corresponding to the adjacent pixels q, s, r and t, so as to obtain the image value Yg′ of the sampling map coordinate position g′.

Similarly, adjacent pixels (not shown in the figure) of the main mapped coordinate position a′ are also selected, and interpolation operations are performed according to the image values corresponding to the adjacent pixels to obtain the image value Ya′ corresponding to the main mapped coordinate position a′. The image values Yb′, Ye′ and Yf′ corresponding to the main mapped coordinate positions b′, e′ and f′ are obtained by a similar interpolation operation.

Referring to FIG. 12A again, the first depth information dA-dF each has a weight value. A weighting operation is performed according to the first depth information dA-dF and their corresponding weight values, so as to obtain the fused depth information dG of the sampling coordinate position G. In one example, the weight values of the first depth information dA, dB, dE and dF are error weights weA, weB, weE and weF, and the error weights weA, weB, weE, weF are related to the image-value-error |(Yg′-Ya′)|, |(Yg′-Ya′)|, |(Yg′-Ye′)| and |(Yg′-Yf′)|. Wherein, the image-value-error |(Yg′-Ya′)| is the absolute value of the difference between the image value Ya′ corresponding to the main mapped coordinate position a′ and the image value Yg′ corresponding to the sampling mapped coordinate position g′, and so on. The image-value-error |(Yg′-Ya′)|, |(Yg′-Yb′)|, |(Yg′-Ye′)| and |(Yg′-Yf′)| are inputted to the error weight function we( ) to generate error weights weA, weB, weE and weF, as shown in equation (14):

wej=we(|(Yg′-Yi′)|)j=A,B,E,F i=a,b,e,f (14)

Then, according to the error weights weA, weB, weE and weF, the weighting operation of the first depth information dA, dB, dE and dF is performed to obtain the fused depth information dG of the sampling coordinate position G, as shown in equation (15):

$$dG = \frac{{\sum }_{j = A , B , E , F} ( dj * wej )}{{\sum }_{j = A , B , E , F} ( wej )} = \frac{d A * w e A + d B * w e B + d E * w e E + d F * w e F}{w e A + w e B + w e E + w e F} \qquad ( 15 )$$

Similarly, the same fusion operation is performed for the other 11 sampling coordinate positions than the sampling coordinate position G (shown as the coordinate positions with the dark screen bottom in FIG. 12A) to obtain the corresponding fused depth information. Each the fused depth information is integrated into the overall fused depth information fD2.

In an example, when the first coordinate positions A-F are arranged in a rectangle, and the main mapped coordinate positions a′-f′ corresponding to the image IMG2′ are also arranged in a rectangle, the interpolation operation of the sampling mapped coordinate position g′ may be relatively simple. In another example (not shown in FIGS. 12A and 12B), the first coordinate positions A-F may be converted into the converted image IMG1_t in advance through depth image based rendering (DIBR). The optical center of the converted image IMG1_t is the same as the optical center of the second sensor 200c, so the converted image IMG1_t may linearly correspond to the image IMG2′, that is, the converted image IMG1_t is only a scaling of size relative to the image IMG2′. Accordingly, the image IMG2′ may also be mapped to the converted image IMG1_t in a reverse direction.

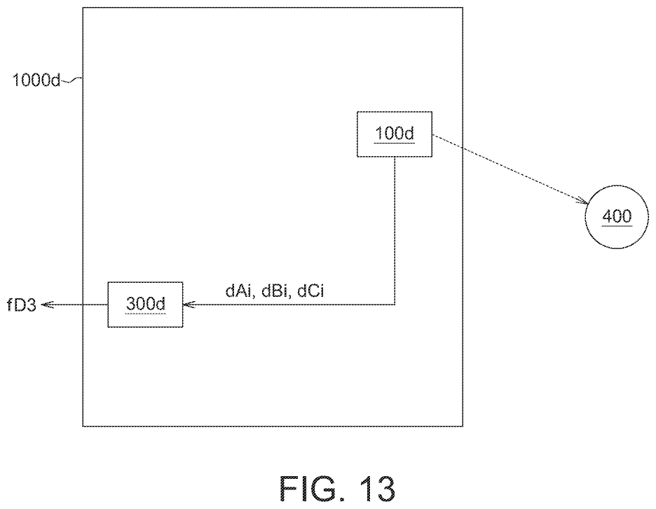

FIG. 13 is a schematic diagram of a sensing device 1000c according to yet another embodiment of the present disclosure. Compared with the sensing device 1000 of the embodiment in FIG. 1A which includes the first sensor 100 and the second sensor 200, the sensing device 1000c of the present embodiment only includes the first sensor 100c but not include other sensors. The first sensor 100c senses the target 400 to generate a plurality of first depth information dAi, dBi and dCi. In an example, the first depth information dAi, dBi, and dCi are generated by the first sensor 100c at different time points ti. The computing unit 300c processes the first depth information dAi, dBi and dCi, and performs a fusion operation, so as to generate fused depth information fD3.

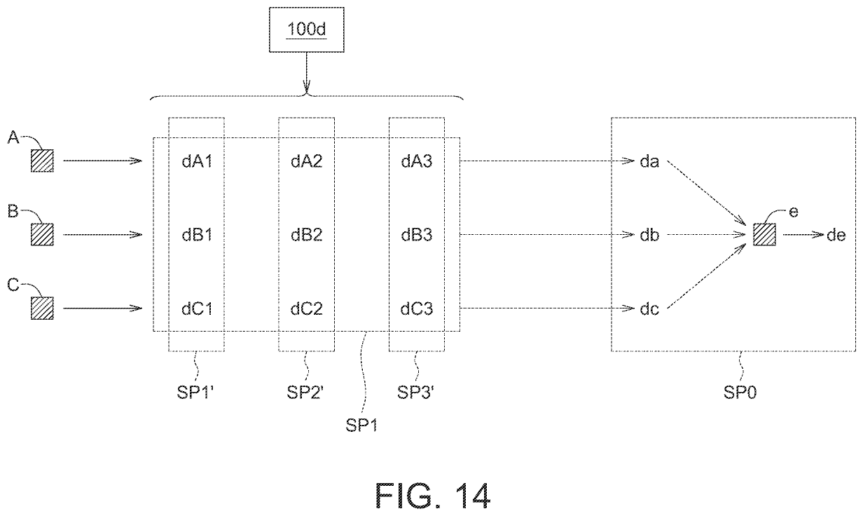

FIG. 14 is a schematic diagram showing the fusion operation performed by the sensing device 1000c of FIG. 13. As shown in FIG. 14, the first sensor 100c senses the first depth information dA1, dB1 and dC1 at the time point t1, and obtains the first depth information dA2, dB2 and dC2 at the time point t2, and obtains the first depth information dA3, dB3 and dC3 at the time point t3. In an example, the first depth information dAi, dBi and dCi generated at different time points ti are all related to the same first space SP1, and the first space SP1 has a plurality of first coordinate positions A, B and C. The depth information dAi, dBi and dCi correspond to the first coordinate positions A, B and C respectively.

In another example, the first depth information dAi, dBi and dCi sensed at different time points ti may be related to different coordinate spaces. For example, the first depth information dA1, dB1, dC1 obtained at time point t1 are related to the first space SP1′, the first depth information dA2, dB2, dC2 obtained at time point t2 is related to the second space SP2′, and the first depth information dA3, dB3, dC3 obtained at the time point t3 are related to the third space SP3′.

On the other hand, a standard space SP0 is a coordinate space corresponding to the real-world, that is, the standard space SP0 is a “unity coordinate system” or a “world coordinate system”. The standard space SP0 and the first space SP1 (or, the first space SP1′, the second space SP2′, the third space SP3′) have a corresponding-relationship or a mapping-relationship of space conversion. The computing unit 300c converts the first depth information dAi, dBi and dCi into second depth information da, db and dc of the standard space SP0 according to the space conversion between the standard space SP0 and the first space SP1 (or, the first space SP1′, the second space SP2′, the third space SP3′). The standard space SP0 has at least one second coordinate position (e.g., the second coordinate position e).

The computing unit 300c determines whether the plurality of second depth information da, db and dc point to the same one of the second coordinate positions. For example, when all the second depth information da, db and dc point to the same second coordinate position e, it means that all the second depth information da, db and dc point to the same physical position in the coordinate space of the real-world. Hence, a fusion operation is performed on the second depth information da, db and dc to obtain the fused depth information de at the second coordinate position e.

The fusion operation performed by the computing unit 300c is, for example, a weighting operation performed according to the second depth information da, db and dc and the corresponding weight values. The second depth information da, db and dc and the corresponding weight values are, for example, the confidence weights wca, wcb and wcc. Furthermore, the confidence weights wca, wcb and wcc may be calculated by the confidence weight function wc( ) of the equation (7-1). The second depth information da, db and dc have confidence levels CLa, CLb and CLc, which are related to the cost value of the block matching of the first sensor 100c or the reflected light intensity of the target 400. The confidence levels CLa, CLb and CLc are respectively inputted to the confidence weight function wc( ) so as to correspondingly output confidence weights wca, wcb and wcc. The confidence weight function wc( ) is, for example, linear function conversion, nonlinear function conversion, or look-up-table conversion. When the inputted confidence levels CLa, CLb and CLc are larger, the correspondingly outputted confidence weights wca, wcb and wcc are larger.

Then, according to the confidence weights wca, wcb and wcc, a weighting operation is performed on the second depth information da, db and dc to obtain the fused depth information de of the second coordinate position e, as shown in equation (16):

$$de = \frac{da * ( wca ) + d b * ( w c b ) + d c * ( w c c )}{w c a + w c b + w c c} \qquad ( 16 )$$

Based on the same fusion operation mechanism, the fused depth information of other coordinate positions in the standard space SP0 is calculated. The fused depth information of each coordinate position of the standard space SP0 is integrated into the overall fused depth information fD3.

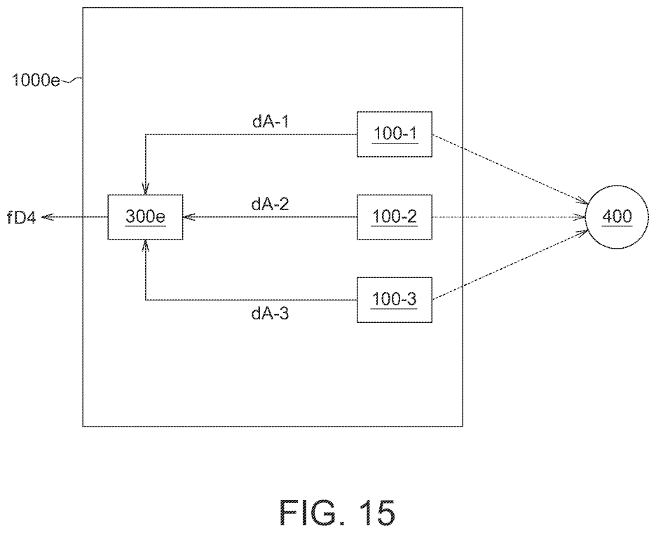

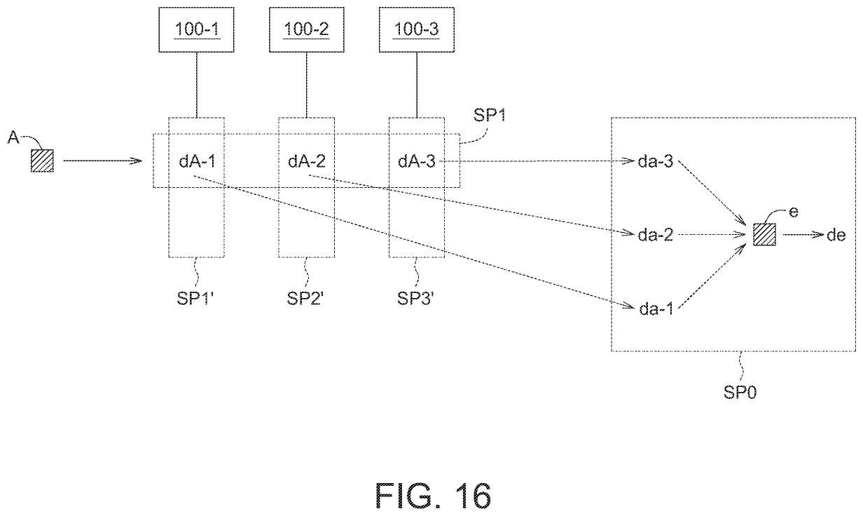

FIG. 15 is a schematic diagram of a sensing device 1000d according to still another embodiment of the present disclosure. Compared with the sensing device 1000c of the embodiment in FIG. 13 which includes only one first sensor 100c, the sensing device 1000d of the present embodiment includes a plurality of sensors, for example, three sensors 100-1, 100-2 and 100-3. Furthermore, FIG. 16 is a schematic diagram showing the fusion operation performed by the sensing device 1000d of FIG. 15. Please refer to FIGS. 15 and 16, taking the same first coordinate position A as an example, the sensors 100-1, 100-2 and 100-3 respectively obtain a plurality of first depth information of the first coordinate position A. For example, the sensor 100-1 senses the first depth information dA-1 of the first coordinate position A, and the sensor 100-2 senses the first depth information dA-2 of the first coordinate position A. Likewise, the sensor 100-3 senses the first depth information dA-3 of the first coordinate position A.

In one example, the first depth information dA-1, dA-2 and dA-3 generated by the sensors 100-1, 100-2 and 100-3 are all related to the same coordinate space, for example, the first depth information dA-1, dA-2 and dA-3 are all related to the same first space SP1. The computing unit 300d converts the first depth information dA-1, dA-2 and dA-3 into the second depth information da-1, da-2 and da-3 of the standard intermediate SP0.

In another example, the first depth information dA-1, dA-2 and dA-3 generated by the sensors 100-1, 100-2 and 100-3 are related to different coordinate spaces. For example, the first depth information dA1 generated by the sensor 100-1 is related to the first space SP1′, the first depth information dA2 generated by the sensor 100-2 is related to the second space SP2′, and the first depth information dA3 generated by the sensor 100-2 is related to the third space SP3′. The computing unit 300d converts the first depth information dA-1 of the first space SP1′, the first depth information dA-2 of the second space SP2′ and the first depth information dA-3 of the third space SP3′ into the second depth information da-1, da-2 and da-3 of the standard space SP0.

When the second depth information da-1, da-2 and da-3 all point to the same second coordinate position e in the standard space SP0, the computing unit 300c uses the second depth information da, db and dc and the corresponding confidence weight wca1, wca2 and wca3 to perform weighting operation, so as to obtain the fused depth information de of the second coordinate position e, as shown in equation (17):

$$de = \frac{d a - 1 * w c a 1 + d a - 2 * w c a 2 + d a - 3 * w c a 3}{w c a 1 + w c a 2 + w c a 3} \qquad ( 17 )$$

Similarly, the fused depth information of each coordinate position of the standard space SP0 is integrated into the overall fused depth information fD4.

It will be apparent to those skilled in the art that various modifications and variations may be made to the disclosed embodiments. It is intended that the specification and examples be considered as exemplary only, with a true scope of the present disclosure being indicated by the following claims and their equivalents.

What is claimed is:

1. A sensing device, comprising:
a first sensor, for generating a plurality of first depth information, wherein the first depth information has a first sampling rate and a first precision;
a second sensor, for generating a plurality of second depth information, wherein the second depth information has a second sampling rate and a second precision, the second sampling rate is greater than the first sampling rate, and the second precision is less than the first precision; and
a computing unit, configured to perform a fusion operation according to the first depth information and the second depth information to obtain a fused depth information, the fused depth information has the first precision and the second sampling rate.

2. The sensing device of claim 1, wherein the first depth information corresponds to a plurality of first coordinate positions of a projection plane, and the second depth information corresponds to a plurality of second coordinate positions of the projection plane, the fusion operation performed by the computing unit comprises:
mapping an original coordinate position of the second coordinate positions to a mapped coordinate position, and the mapped coordinate position is located among the first coordinate positions;
selecting a plurality of engaging coordinate positions from the first coordinate positions according to the mapped coordinate position; and
performing a weighting operation according to the first depth information corresponding to each of the engaging coordinate positions and the second depth information corresponding to the original coordinate position to obtain the fused depth information, and the fused depth information corresponds to the mapped coordinate position.

3. The sensing device of claim 2, wherein the engaging coordinate positions are adjacent to the mapped coordinate position, the first depth information corresponding to each of the engaging coordinate positions has a weight value, and the computing unit performs the weighting operation at least according to the first depth information corresponding to each of the engaging coordinate positions and the weight value.

4. The sensing device of claim 3, wherein the weight value is an error weight, and the error weight is related to an absolute error value between the first depth information corresponding to each of the engaging coordinate positions and the second depth information corresponding to the original coordinate position.

5. The sensing device of claim 3, wherein the weight value is a distance weight, and the distance weight is related to a length of a relative distance between each of the engaging coordinate positions and the mapped coordinate position.

6. The sensing device of claim 3, wherein the weight value is an area weight, and the area weight is related to a size of a relative area between each of the engaging coordinate positions and the mapped coordinate position.

7. The sensing device of claim 3, wherein the first depth information corresponding to the engaging coordinate positions has a first confidence weight, and the second depth information corresponding to the original coordinate position has a second confidence weight, the computing unit performs the weighting operation according to the first depth information corresponding to the engaging coordinate positions, the first confidence weight, the second depth information corresponding to the original coordinate position and the second confidence weight.

8. The sensing device of claim 1, wherein the computing unit is further configured to:
calculate a basis value of the second depth information;
calculate an offset value of each of the second depth information with respect to the basis value; and
correct the fused depth information according to the offset values of the second depth information.

9. The sensing device of claim 2, wherein the first sensor and the second sensor have a plurality of intrinsic parameters and a plurality of extrinsic parameters, and the computing unit maps the original coordinate position to the mapped coordinate position according to the intrinsic parameters and/or the extrinsic parameters.

10. The sensing device of claim 9, wherein the first sensor is a radar sensor or a depth sensor using time-of-flight (ToF), and the second sensor is a color sensor, a Lidar sensor or a stereoscopic sensor.

11. A sensing device, comprising:
a first sensor, for generating a plurality of first depth information, wherein the first depth information has a first sampling rate and a first precision;
a second sensor, for generating a plurality of pixels and a plurality of image values, the image values respectively correspond to the pixels, wherein the pixels have a resolution, and a sampling rate corresponding to the resolution is greater than the first sampling rate; and
a computing unit, configured to perform a fusion operation according to the first depth information and the image values to obtain a fused depth information, the fused depth information has the first precision, and a sampling rate of the fused depth information is substantially equal to the sampling rate corresponding to the resolution of the pixels.

12. The sensing device of claim 11, wherein the pixels generated by the second sensor form an image, and the fusion operation performed by the computing unit comprises:
establishing a sampling coordinate position among the first coordinate positions;
mapping the first coordinate positions to a plurality of main mapped coordinate positions, the main mapped coordinate positions are located in the image;
mapping the sampling coordinate position to a sampling mapped coordinate position, the sampling mapped coordinate position is located in the image; and
performing a weighting operation according to the first depth information corresponding to each of the first coordinate positions, the image value corresponding to each of the main mapped coordinate positions and the image value corresponding to the sampling mapped coordinate position to obtain the fused depth information, the fused depth information corresponds to the sampling coordinate position.

13. The sensing device of claim 12, wherein the computing unit selects a plurality of adjacent pixels from the pixels, the adjacent pixels are adjacent to the sampling mapped coordinate position and the main mapped coordinate positions, and the computing unit performs an interpolation operation according to the image values corresponding to the adjacent pixels to obtain the image values corresponding to the sampling mapped coordinate positions and the main mapped coordinate positions.

14. The sensing device of claim 12, wherein each of the first depth information has a weight value, and the computing unit performs the weighting operation at least according to each of the first depth information and the corresponding weight value.

15. The sensing device of claim 14, wherein the weight value of each of the first depth information is an error weight, and the error weight is related to an image-value-error between the image value corresponding to each of the main mapped coordinate positions and the image value corresponding to the sampling mapped coordinate positions.

16. A sensing device, comprising:
a first sensor, for generating a plurality of first depth information, the first depth information is related to at least one first space, the at least one first space has a plurality of first coordinate positions, the first depth information respectively corresponds to the first coordinate positions; and
a computing unit, configured to convert the first depth information into a plurality of second depth information, the second depth information is related to a standard space, and the standard space has at least one second coordinate position;
wherein, when the second depth information points to the same one of the second coordinate position, the computing unit performs a fusion operation according to the second depth information to obtain a fused depth information of the second coordinate position.

17. The sensing device of claim 16, wherein the first sensor generates the first depth information at different time points, and the standard space corresponds to a real-world coordinate system.

18. The sensing device of claim 17, wherein the computing unit converts the first depth information into the second depth information according to a space conversion between the at least one first space and the standard space.

19. The sensing device of claim 16, wherein each of the second depth information has a weight value, and the computing unit performs the fusion operation at least according to each of the second depth information and the corresponding weight value.

20. The sensing device of claim 19, wherein the weight value of each of the second depth information is a confidence weight, and the confidence weight is related to a confidence level of each of the second depth information.
